(19) United States
(12) Patent Application Publication
(10) Pub. No.: US 2026/0154528 A1
(43) Pub. Date: Jun. 4, 2026

(54) Apparatus for Plausible Neural Network Artificial Intelligence (PNNAI) Engine

(71) Applicant: PNN Technologies, Woodbridge, VA (US)

(72) Inventor: Yuan Yan Chen, Woodbridge, VA (US)

(73) Assignee: PNN Technologies, Woodbridge, VA (US)

(21) Appl. No.: 18/967,087

(22) Filed: Dec. 3, 2024

(51) Int. Cl. G06N 3/045; G06N 3/088

(52) U.S. Cl. CPC G06N 3/045; G06N 3/088

(57) ABSTRACT

A method of training a hierarchical neural network in hardware comprising a plurality of neurons having tree structure connections between respective ones of the plurality of neurons to compute plausible inferences based on input data. The method includes initiating a WTA neuron ensemble to connect to data input neurons and produce a winner-take-all, attaching data records match with top neurons and branching out at WTA junctions to form a hierarchy network tree, converting a stream of the input data into neuron bipolar signals, updating neuron weights with Hebbian and anti-Hebbian rules, and repeating the attaching, converting, and updating until the input data is exhausted.

### FIELD OF THE DISCLOSURE

The present disclosure is related to neural networks and artificial general intelligence, and in particular, to a neural network model that mimics many human cognition capabilities, such as understanding, knowledge acquisition, forecasting, decision-making, reasoning, logic, belief, and inference, which is scalable, parallel distributed, and suitable for digital and analog computational hardware.

### BACKGROUND OF THE INVENTION

The world's technological per-capita capacity to store information has increased dramatically in the last few decades. The amount of data is over a trillion gigabytes. Machine learning tools that analyze such a significant amount of data must be scalable. The trained networks need to be transparent and easily communicate with humans or, even better, serve as super-intelligent systems.

### SUMMARY OF THE INVENTION

In some embodiments, a method of training a hierarchical neural network in hardware. The hierarchical neural network includes a plurality of neurons having tree structure connections between respective ones of the plurality of neurons to compute plausible inferences based on input data. The method includes initiating a winner-take-all (WTA) neuron ensemble to connect to data input neurons and produce a winner-take-all. The method further includes attaching data records matching with top neurons and branching out at WTA junctions to form a hierarchy network tree. The method further includes converting a stream of the input data into neuron bipolar signals. The method further includes updating neuron weights with Hebbian and anti-Hebbian rules. The method further includes repeating the attaching, converting, and updating until the input data is exhausted.

In some embodiments, a non-transitory computer readable medium is disclosed herein. The non-transitory computer readable medium has programming instructions stored thereon, which, when executed by a processor, causes a computing system to perform operations for training a hierarchical neural network in hardware. The hierarchical neural network includes a plurality of neurons having tree structure connections between respective ones of the plurality of neurons to compute plausible inferences based on input data. The operations include initiating a winner-take-all (WTA) neuron ensemble to connect to data input neurons and produce a winner-take-all. The operations further include attaching data records match with top neurons and branching out at WTA junctions to form a hierarchy network tree. The operations further include converting a stream of the input data into neuron bipolar signals. The operations further include updating neuron weights with Hebbian and anti-Hebbian rules. The operations further include repeating the attaching, converting, and updating until the input data is exhausted.

In some embodiments, a hierarchical neural network formed in hardware is disclosed herein. the hierarchical neural network includes a plurality of neurons having tree structure connections between respective ones of the plurality of neurons to compute plausible inferences based on input data. The hardware is a parallel distributed computation machine. The parallel distributed computation machine includes a plurality of parallel processors and the hierarchical neural network is distributed across the plurality of parallel processors.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a computing environment, according to example embodiments.

FIG. 2 illustrates an architecture of a PNNAI network, according to example embodiments.

FIG. 3 illustrates Boolean logic rules in terms of neural computation in PNNAI network, according to example embodiments.

FIG. 4 illustrates an exemplary ternary logic gate in terms of neural computation in PNNAI network, according to example embodiments.

FIG. 5 illustrates an exemplary winner-take-all neural computation in PNNAI network, according to example embodiments.

FIG. 6 illustrates an exemplary pyramid coding of numerical data values in PNNAI network, according to example embodiments.

FIG. 7 illustrates a computing environment for training PNNAI network, according to example embodiments.

FIG. 8 illustrates exemplary weights updates during network training with the Hebbian and Anti-Hebbian rules, according to example embodiments.

FIG. 9 illustrates an exemplary classification schema in a trained PNNAI network, according to example embodiments.

FIG. 10 illustrates a merging of two PNNAI networks, according to example embodiments.

FIG. 11 illustrates the flowchart of PNNAI training and organization, according to example embodiments.

FIG. 12A is a block diagram illustrating a computing device, according to example embodiments of the present disclosure.

FIG. 12B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Artificial intelligence and machine learning are solving many real-world problems. However, a complete comprehension of many of the “unsolved” issues in these fields is hindered due to the fundamental limitations of many artificial intelligence computational models. For example, deep learning models do not have the calculus of the machinery or the physics to have a calculus of belief, inference, planning, or situation awareness.

Plausible Neural Network Artificial Intelligence (PNNAI) has been developed to address these issues. PNNAI is a complex neural network and artificial intelligence computational model for mimicking higher-order human cognitive capabilities, such as understanding, knowledge acquisition, forecasting, decision-making, reasoning, logic, belief, and inference. The PNNAI network has a decentralized hierarchical structure, similar to the World Wide Web, with hubs linked to sub-hubs down to each subnetwork. Such a design is most efficient for signal transmission.

PNNAI is an extension of the Plausible Neural Network (PLANN) model, previously invented by one of the same inventors in U.S. Pat. No. 7,287,014 entitled “Plausible Neural Network with Supervised and Unsupervised Cluster Analysis,” which is incorporated by reference herein.

The hierarchical organization of neural networks is well known in the literature (see, e.g., Zhou C, Zemanová L, Zamora G, Hilgetag C C, Kurths J, Hierarchical organization unveiled by functional connectivity in complex brain networks. Physics Review Letter 2006 Dec. 8; 97(23)). Most hierarchical neural networks are based on bottom-up approaches. A few small-scale top-down approaches have been discussed in the literature (see e.g., Breiman L, Friedman J H, Olshen R A, Stone C J. Classification and Regression Trees. CRC Press; 1984 and Quinlan, J. R. (1986). Induction of decision trees. Machine Learning, 1, 81-106.) Neural networks perform analog computation, which is well-known in the literature (see e.g., Carver Mead (1985) Analog VLSI and Neural Systems).

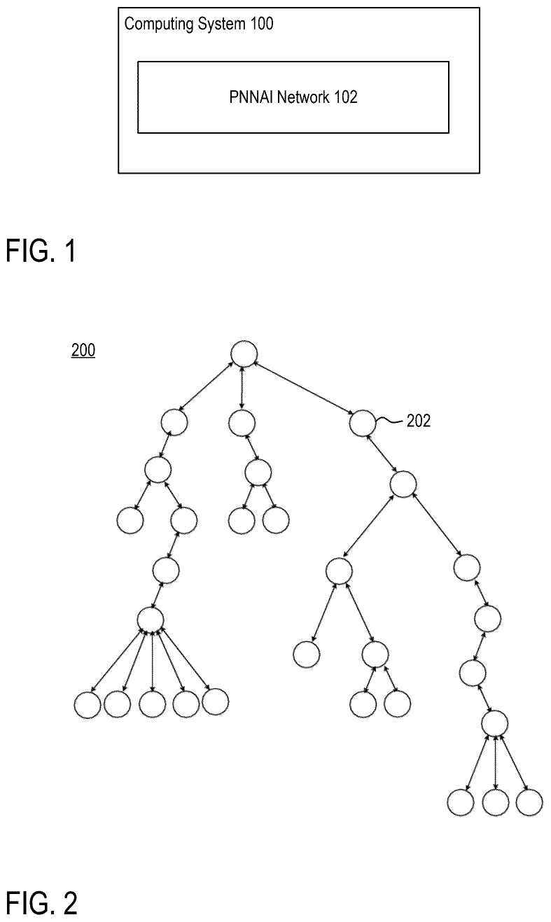

FIG. 1 illustrates a computing system 100, according to example embodiments. Computing system 100 may be representative of one or more computing devices configured to host and execute a PNNAI network 102. PNNAI network 102 is a complex neural network trained to mimic higher-order human cognitive capabilities. In some embodiments, computing system 100 may be representative of a parallel distributed computation device with memory synapses. For example, computing system 100 may include memristor hardware, which are able to naturally compute tree structures.

In some embodiments, computing system 100 may be representative of one or more networked computers that function as a server system for hosting PNNAI network 102. In such embodiments, end users may access functionality of PNNAI network 102 via an application executing on their user device similar to a software-as-a-service (SaaS) system.

FIG. 2 illustrates an architecture of a PNNAI network (hereinafter “PNNAI architecture 200”), according to example embodiments. PNNAI architecture 200 is a decentralized hierarchical structure, similar to the World Wide Web, with hubs linked to sub-hubs down to each subnetwork. This type of design is most efficient for signal transmission. PNNAI architecture 200 is shown as a tree structure have a plurality of neurons 202, where each parent-downward-branching represents a Winner-Take-All (WTA) neuron ensemble. The WTA circuit is an essential neuron computation unit in a neural network. Each WTA neuron ensemble corresponds to a statistical variable described in the PLANN model. For example, a competitive neuron ensemble may include a plurality of neurons, and corresponds to a variable in the statistical inference, with each neuron in the ensemble representing a possible value of the variable. The variable can be continuous or discrete, and it can represent a sample space or a hypothesis space. If the variable is discrete with k categories, it can be encoded by X=(X₁, X₂, . . . , Xₖ). Thus, each neuron is an indicator function of a particular data value.

PNNAI neuron signals are bipolar 1 or −1, with 0 representing neurons at rest. During probability and belief logic inference, under certainty, reduced to Boolean logic rules, for detail.

As previously discussed, PNNAI conceptually extends the PLANN model. In particular, the PLANN signal is analog in [0,1], while the PNNAI signals are analog in [−1,1]. Mathematically, they are equivalent to a simple transformation. For propositional logic, the signals are binary versus bipolar signals. However, for uncertainty, it is more natural to represent belief logic in [−1,1]. For example, in Bayesian inference, the completely unknown is usually described as ½, which will be confused with a chance of ½, as in coin tossing. For belief logic in [−1,1], the completely unknown is represented as 0. In the PNNAI model, 0 also represents neurons at rest, which halts the signal propagation; hence, it plays a vital role in controlling the signal flow of a network. Bayesian networks have no such capability.

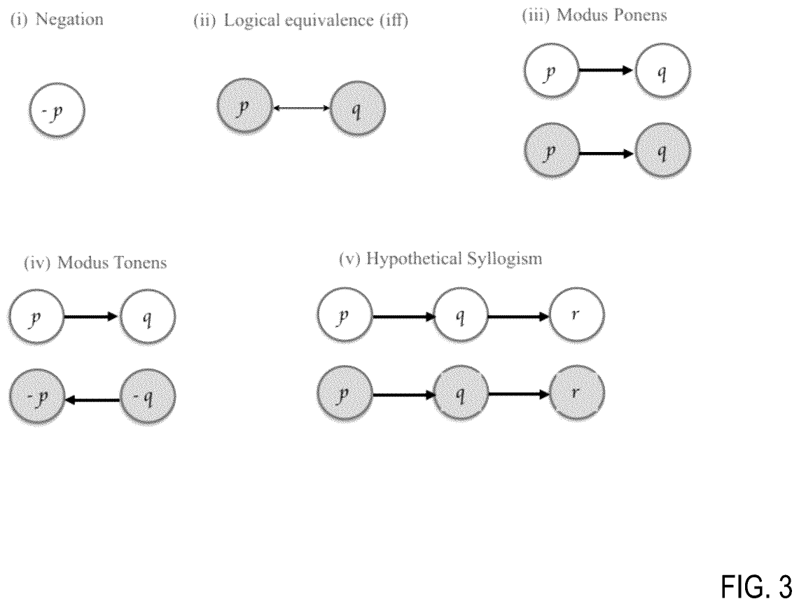

FIG. 3 demonstrates exemplary Boolean logic operations within PNNAI network 102 with corresponding network computation, according to example embodiments. As shown, p and −p represent propositions—Truth and False, respectively. Neuron signal transmission from neuron p to neuron q is interpreted as logical propositions “if p then q” where activated neurons are shaded. Note that weight is positive; a True proposition activates a Truth proposition, such as Modus Pones. Similarly, a False proposition activates a False proposition, such as Modus Tonens.

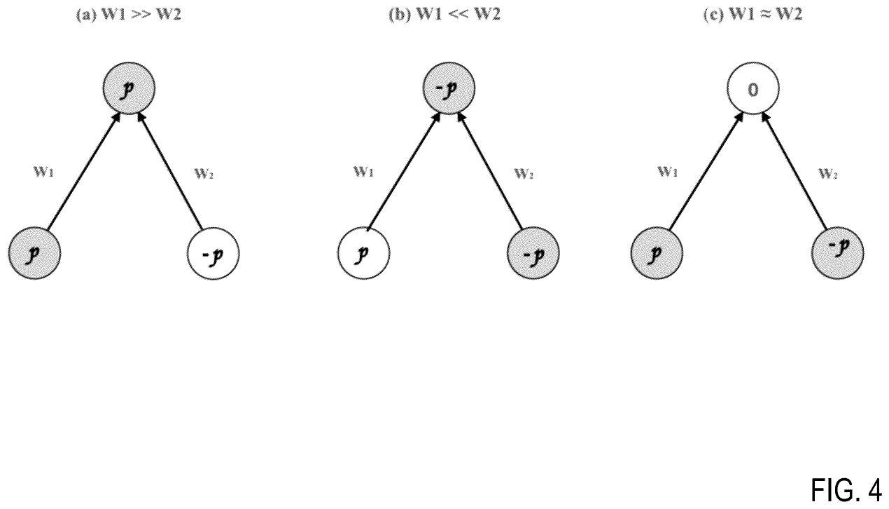

FIG. 4 illustrates an exemplary bipolar signal neural computation of belief logic within PNNAI network 102, according to example embodiments. The propositions p, −p, and 0 are shown representing Truth, False, and Unknown, respectively. Although PNNAI network 102 may compute with bipolar signals, with 0 representing neurons at rest, PNNAI network 102 may perform a ternary logic gate. Belief logic is essential for pattern recognition and knowledge extraction. Data values are coded into a WTA neuron ensemble for discrete variables.

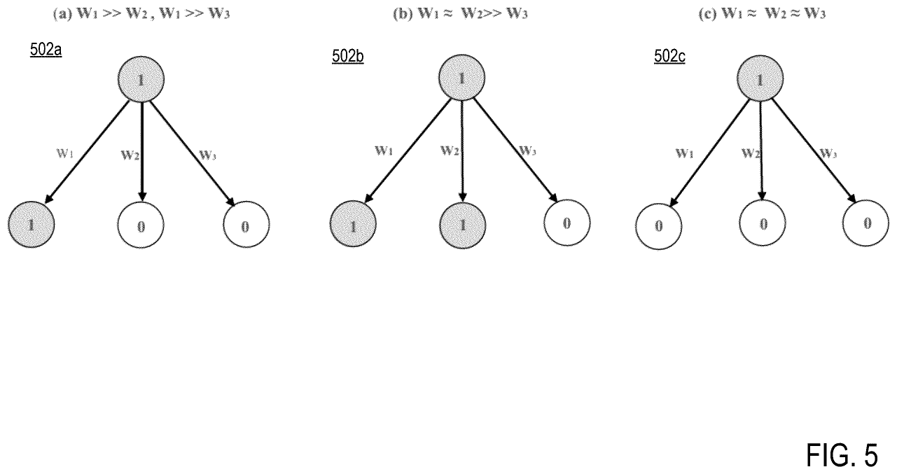

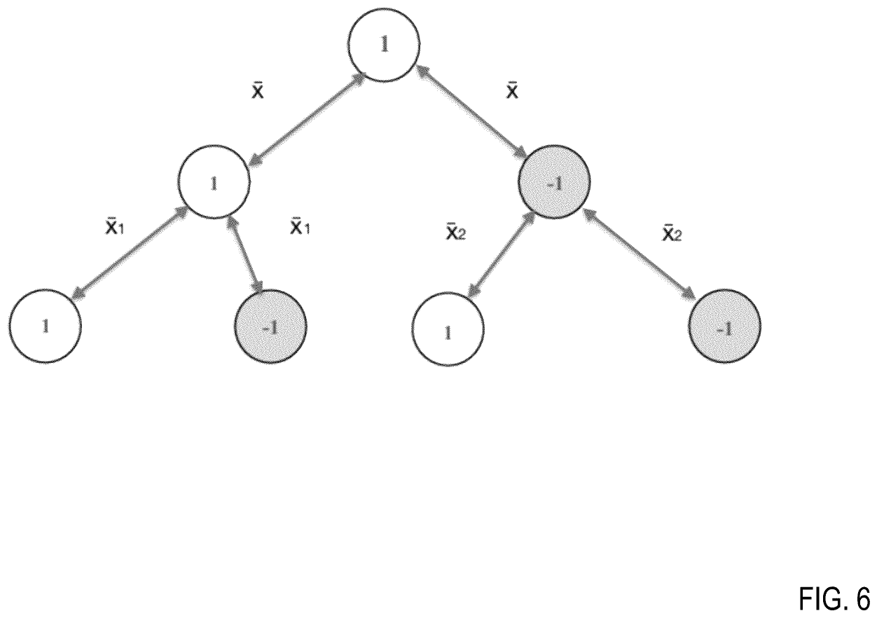

FIG. 5 illustrates exemplary computations of a WTA neuron ensemble, according to example embodiments. Initially, bottom neurons may send signals upward. The inhibition from the top neuron signal produces a contrast difference between the bottom neuron signals. For example, as shown, scenario 502a may correspond to max, scenario 502b may correspond to softmax, and scenario 502c corresponds to no contrast. Contrast computation is well observed in the visual cortex; neurons are active for edge detection, and neurons are inactivated if the background is uniform. In belief logic, scenario 502c may be interpreted as follows: if all possibilities are equally likely, it produces no beliefs.

FIG. 6 illustrates exemplary pyramid encoding/encoding of data variables in PNNAI network 102, according to example embodiments. For example, for continuous variables, data values may be encoded into a pyramid of bipolar neuron signals. In operation, PNNAI network 102 may calculate the data average. Second-level data may be separated into above and below-average groups, which are indicated by 1 and −1. Each data layer is averaged and sent it to the next level. Encode the next level similar to the second level, except the average is the corresponding group average. This process repeats iteratively; the more level, the more detail for the data encoding. For decoding, PNNAI network 102 multiplies bipolar signals with the local average in the corresponding level, then adds them together.

The PNNAI weight connection is the mutual information content discussed in the PLANN model. The weight connection between neuron Xᵢ and neuron Yⱼ is given below.

$${w}_{ij} = ln ( P ( {X}_{i} , {Y}_{j} ) / P ( {X}_{i} ) P ( {Y}_{j} ) ) , if {w}_{ij} > 0 \qquad ( 1 )$$

$${w}_{ij} = 0 , otherwise .$$

The Hyperbolic Tangent function is commonly used for signal activation for bipolar neural networks, which is suitable for analog hardware. For digital hardware, PNNAI employs a truncated Hyperbolic Tangent function to facilitate computation. The signal activation function is as follows for neuron yⱼ, which receives signals from neurons x₁, . . . , xₙ;

$${y}_{j} = 1 , if s ( {S}_{i} {w}_{ij} {x}_{i} ) < a , \qquad ( 2 )$$

$${y}_{j} = - 1 , if s ( {S}_{i} {w}_{ij} {x}_{i} ) < - a ,$$

$${y}_{j} = 0 , otherwise ;$$

where a is a threshold constant.

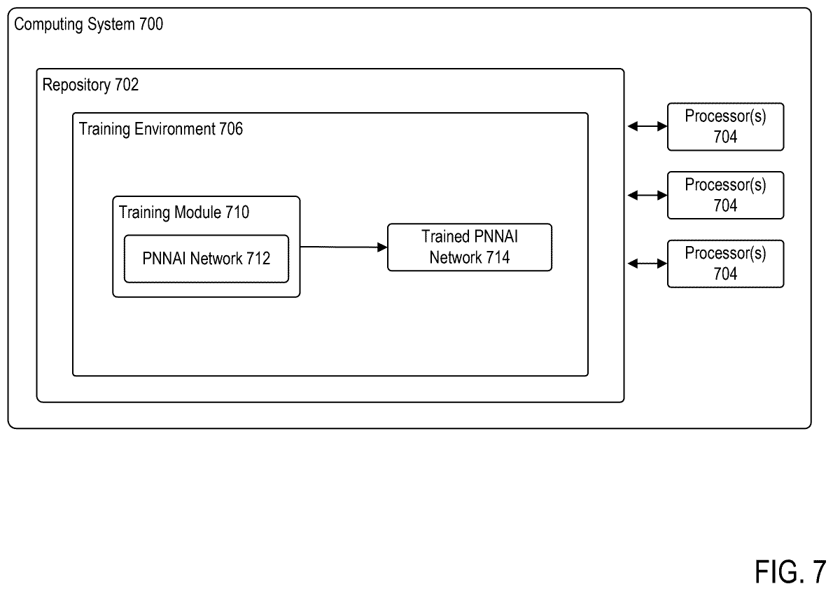

FIG. 7 is a block diagram illustrating a computing system 700, according to example embodiments. As shown, FIG. 7 may represent an example environment in which PNNAI network may be trained. Computing system 700 may include a repository 702, training environment 706, and one or more computer processors 704.

Repository 702 may be representative of any type of storage unit and/or device (e.g., a file system, database collection of tables, or any other storage mechanism) for storing data. In some embodiments, repository 702 may include multiple different storage units and/or devices. The multiple different storage units and/or devices may or may not be of the same type or located at the same physical site. As shown, repository 702 may include a training environment 706.

Training environment 706 may include training module 710. Training module 710 may be comprised of one or more software modules. The one or more software modules are collections of code or instructions stored on a media (e.g., memory of computing system 700) that represent a series of machine instructions (e.g., program code) that implements one or more algorithmic steps. The machine instructions may be the actual computer code the processor of computing system 700 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

For training, training module 710 may employ real numbers for weight connections, while the rest of the computations are based on bits. Real numbers are required to decode numerical and uncertainty logic values at final outputs for testing.

Training module 710 may train PNNAI network 712 to organize data into many hierarchy tree networks, each specified in a particular knowledge domain. The top layers of the network may represent coarse patterns, with each additional lower layer, more detailed patterns are added. PNNAI network 712 eventually grows into a fine-scale, trained model.

To begin, training module 710 may initiate a WTA neuron ensemble and fire randomly to connect to data input neurons. The top-level neurons inhibit their lower-level neurons (data input signals) and produce a winner-take-all. Training module 710 may attach a data stream that matches the top-level neuron signals and forms a branch. The branches are further divided at the WTA junctions, creating a hierarchy network tree. Each data signal fires forward to neurons in the network. These activated neurons fire back to the data neuron. The signals from the network matched with data signals are retained, while those mismatched are suppressed from the network signals and diminished. The process iterates until it reaches a consonant state.

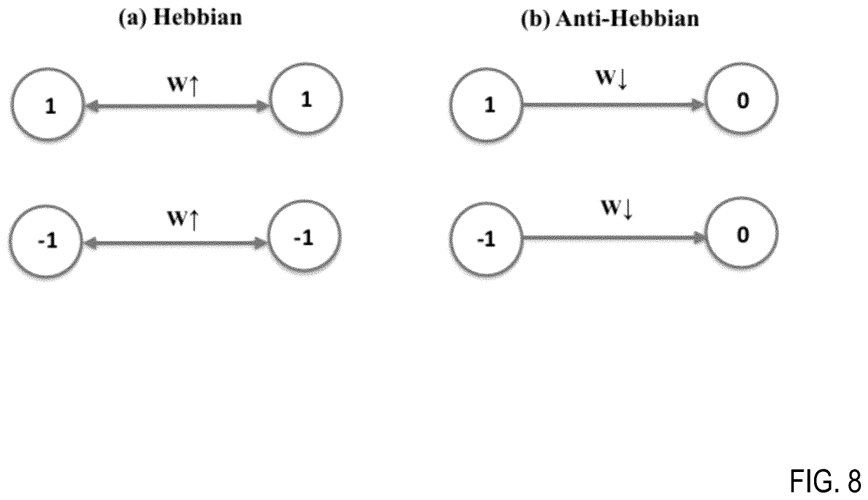

Neurons matched with the data signals increase their connection weights through the Hebbian rule. In contrast, neurons mismatched with the data signals decrease their connection weights through the Anti-Hebbian rule, such as that shown in FIG. 8. All the weight connections are positive values; neurons are removed from the network if their connection weight diminishes.

The data signals that PNNAI network 712 receives may contain variables or attributes unseen by PNNAI network 712. PNNAI network 712 assigns connections to free neurons to match the data signals, which increases the network's size; however, if a newly assigned neuron does not accumulate enough connection weights from the upcoming data stream, its connection weight decreases, and the neuron is removed. Therefore, PNNAI network will not keep growing indefinitely.

A trained PNNAI network 714 is essentially noise-free; even training data is noisy. Generally, PNNAI network 712 initially picks up noise in the data set during training, and because noise fluctuates, its connection weights are weak. When PNNAI network 712 updates with a new data stream, the signals produced are mismatched with network signals and cleaned up by the Anti-Hebbian rule. Each path in a network tree is a compressed and cleaned-up version of trained data records. Data records are retrieved by firing network signals. WTA plays a vital role in regulating signal flow in a network. The activation of lower-level neurons in a branch transmits signals to top-level neurons. Activation of top-level neuron signals would not transmit signals to all branches below; at the WTA junction, signals diffuse and produce no winners.

A trained PNNAI network 714 has many applications, such as, but not limited to classification/function approximation, sequence analysis and forecast, cluster analysis, fraud detection, and pattern recognition.

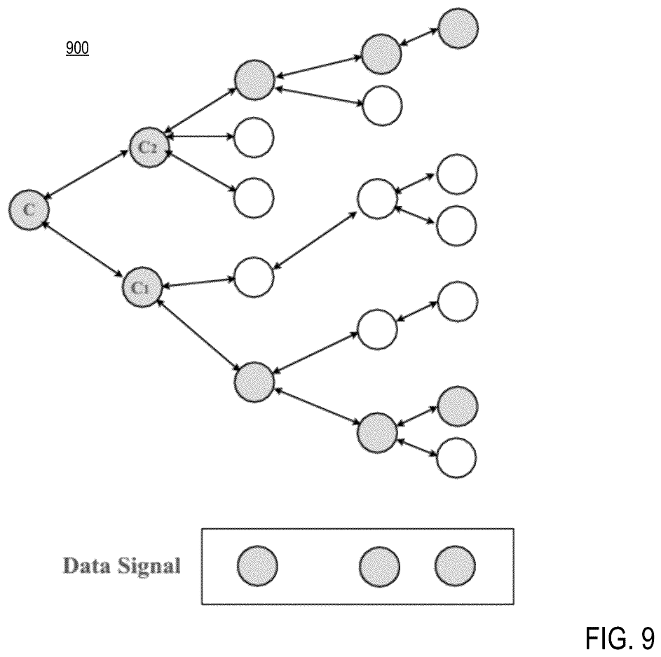

FIG. 9 illustrates a PNNAI network 900 deployed for classification/function approximation, according to example embodiments. For classification/function approximation, input data signals partially match the network neuron signals, triggering the activation of all neurons in the path. At the path intersection, a class neuron then determines the winner. For function approximation, the class neurons are replaced with pyramid neurons. The numerical output values are achieved through the decoding of pyramid neurons.

For sequence analysis and forecast: the sequence data (xₙ,xₙ₊₁) is paired with the time series data (xₜ,xₜ₊₁) and PNNAI network may be trained accordingly. This computation method is equivalent to recurrent neural networks.

For cluster analysis, each branch of the PNNAI network belongs to a different cluster. Higher-level branches provide a coarse pattern of clusters, and lower-level branches provide a detailed pattern of clusters. Together, they form a multi-resolution cluster analysis.

For fraud detection, trained PNNAI networks may contain the profile of users/customers. An anomaly data record sent into the trained PNNAI network may produce a mismatch and contradiction and is rejected by the network.

For pattern recognition, an input pattern to the trained PNNAI network may trigger the neurons to fire along the paths to higher levels. The top-down and bottom-up signals settle for resonance and achieve recognition. If the input signals compete to classify a specific class variable and produce no winner, the signals will be sent upward for further classification. This is why a clear image can be recognized as a particular person, while the same blurred image can only be recognized as the face of a human being.

Each trained PNNAI network can serve as a domain-specific expert system. For information retrieval, each sub-network may be stored on different networks. A query triggers the neurons to fire along the paths to higher levels for knowledge extraction. If the paths meet at a fork, neuron signals compete for a winner. When top-down and bottom-up signals settle for resonance, they produce the output for the query. If there is no apparent winner, the network provides possible answers with uncertainty or requests further information for clarification.

For reasoning and decision-making, exemplary proposition logic is illustrated in FIGS. 3-4. Inductive Logic is a pattern that occurs repeatedly through the learning process and is encoded into a network system. Cause and effect add the timing of learned associated events, e.g., lighting causes thunder. Critical thinking involves analyzing, evaluating, and logically reasoning based on evidence and criteria that naturally fit with PNNAI-trained networks. Decision trees are often used for decision-making. The complexity of the PNNAI network with extensively learned scenarios provides an advanced tool for solving complex problems. Forecast, learn from past events, and predict future events with uncertainty logic.

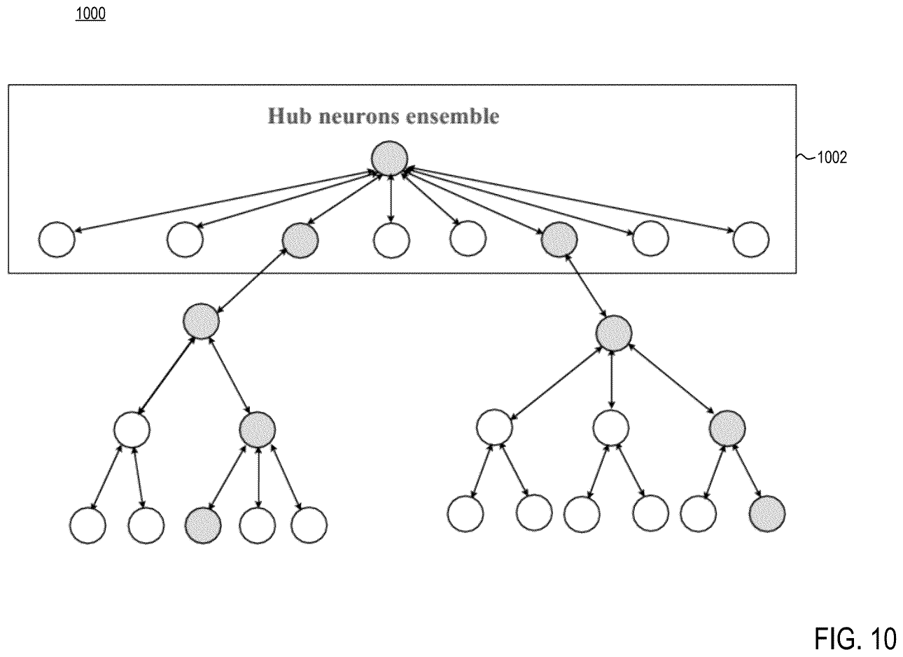

FIG. 10 is a block diagram illustrating a merged PNNAI network 1000, according to example embodiments. As shown, a trained PNNAI network can be merged with other trained PNNAI networks to form merged PNNAI network 1000. To generate a merged PNNAI network, WTA neurons ensemble 1002 may be initiated and fires randomly. The top levels of each PNNAI network may serve as data generators. In operation, a specific WTA neuron is picked as the winner and connected to it. WTA neurons ensemble 1002 then serves as a hub for the networks underneath. Each hub may connect to other hubs through the same procedure, forming a large-scale network system.

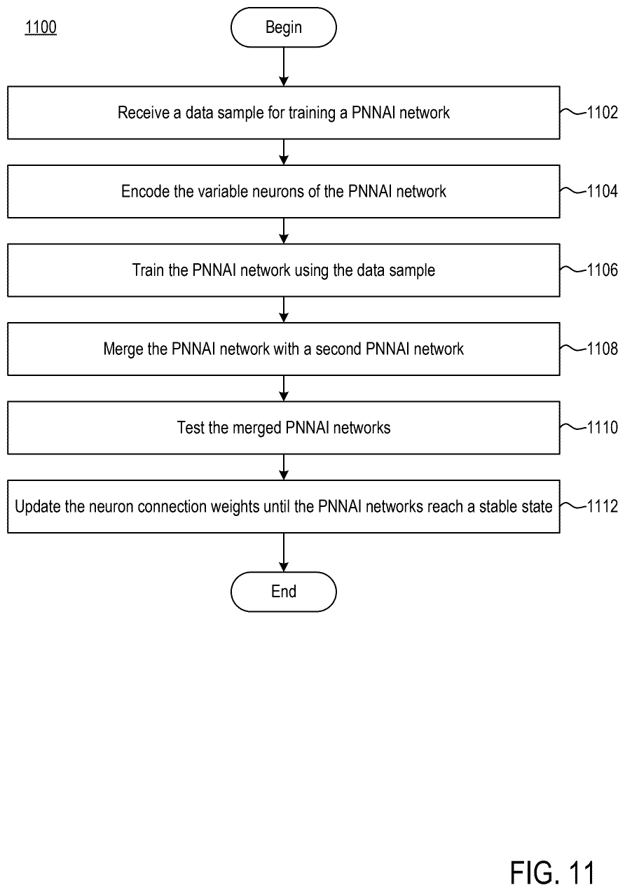

FIG. 11 is a flow diagram illustrating a method 1100 of training a PNNAI network, according to example embodiments. In some embodiments, such as that disclosed below, PNNAI network may be trained without outside data sources.

At step 1102, a computing system receives a data sample for training a PNNAI network. In some embodiments, the domain sample may be representative of a subset of data collected from a specific field or industry that reflects the domain to which the specific field or industry belongs. In some embodiments, the domain sample may be curated by domain experts to ensure that it accurately represents the scenarios PNNAI network is expected to encounter.

At step 1104, the computing system may encode the variable neurons of the PNNAI network. Generally, the variable neurons can be continuous or discrete, and it can represent a sample space or a hypothesis space. If the variable is discrete with k categories, it can be encoded by X=(X₁, X₂, . . . , Xₖ). The encoding/decoding of continuous variables in PNNAI may be based on pyramid coding of bipolar signals where the averages may be recalculated at each level of the pyramid.

At step 1106, the computing system may train the PNNAI network using the data sample. For example, the computing system may initiate a WTA neuron ensemble to connect to data input neurons and produce a winner-take-all. The computing system may attach data records match with top neurons and branching out at WTA junctions to form a hierarchy network tree. The computing system may convert a stream of the input data from the data sample into neuron bipolar signals. The computing system may update the neuron weights with Hebbian and anti-Hebbian rules. This process may be repeated until all data records are exhausted.

At step 1108, the computing system may merge the PNNAI network with a second trained PNNAI network. For example, to merge the PNNAI network with a second PNNAI network, the computing system may initiate WTA neurons ensemble and fire the neurons randomly. The top levels of each PNNAI network may serve as data generators. In operation, a specific WTA neuron is picked as the winner and connected to it. WTA neurons ensemble then serves as a hub for the networks underneath. Each hub may connect to other hubs through the same procedure, forming a large-scale network system.

At step 1110, the computing system may test the merged network. For example, the computing system may implement a testing data set to test the accuracy of the merged PNNAI network.

At step 1112, the computing system may update the neuron connection weights until the PNNAI networks reach a stable state.

In some embodiments, PNNAI training can be implemented in a parallel distributed computing device having a plurality of processors for large-scale network systems, with each PNNAI network trained using a different data resource of the knowledge domain and is then merged with other networks to form a complex distributed network. The trained PNNAI network is constantly updated with new data streams. Major networks with large connection weights would not be eroded through continued learning, while minor subnetworks are adaptive to a new environment. This PNNAI network is a large-scale super-intelligent system. In such embodiments, the input data may be partitioned by attributes and samples into memory segments, distributed among each computer in parallel distributed computing device. Then each hierarchy network may be trained accordingly.

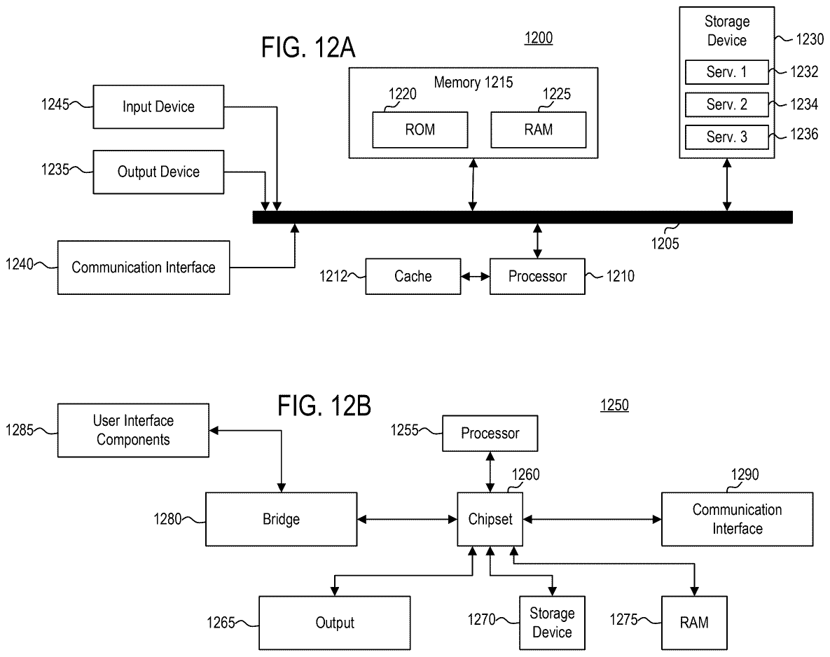

FIG. 12A illustrates a system bus architecture of computing system 1200, according to example embodiments. System 1200 may be representative of at least computing system 100 or computing system 700. One or more components of system 1200 may be in electrical communication with each other using a bus 1205. System 1200 may include a processing unit (CPU or processor) 1210 and a system bus 1205 that couples various system components including the system memory 1215, such as read only memory (ROM) 1220 and random-access memory (RAM) 1225, to processor 1210.

System 1200 may include a cache of high-speed memory connected directly with, in close proximity to, or integrated as part of processor 1210. System 1200 may copy data from memory 1215 and/or storage device 1230 to cache 1212 for quick access by processor 1210. In this way, cache 1212 may provide a performance boost that avoids processor 1210 delays while waiting for data. These and other modules may control or be configured to control processor 1210 to perform various actions. Other system memory 1215 may be available for use as well. Memory 1215 may include multiple different types of memory with different performance characteristics. Processor 1210 may include any general-purpose processor and a hardware module or software module, such as service 1 1232, service 2 1234, and service 3 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction with the computing system 1200, an input device 1245 may represent any number of input mechanisms, such as a microphone for speech, a touch-sensitive screen for gesture or graphical input, keyboard, mouse, motion input, speech and so forth. An output device 1235 may also be one or more of a number of output mechanisms known to those of skill in the art. In some instances, multimodal systems may enable a user to provide multiple types of input to communicate with computing system 1200. Communications interface 1240 may generally govern and manage the user input and system output. There is no restriction on operating on any particular hardware arrangement and therefore the basic features here may easily be substituted for improved hardware or firmware arrangements as they are developed.

Storage device 1230 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1225, read only memory (ROM) 1220, and hybrids thereof.

Storage device 1230 may include services 1232, 1234, and 1236 for controlling the processor 1210. Other hardware or software modules are contemplated. Storage device 1230 may be connected to system bus 1205. In one aspect, a hardware module that performs a particular function may include the software component stored in a computer-readable medium in connection with the necessary hardware components, such as processor 1210, bus 1205, output device 1235 (e.g., display), and so forth, to carry out the function.

FIG. 12B illustrates a computer system 1250 having a chipset architecture that may represent computing system 100 or computing system 700. Computer system 1250 may be an example of computer hardware, software, and firmware that may be used to implement the disclosed technology. System 1250 may include a processor 1255, representative of any number of physically and/or logically distinct resources capable of executing software, firmware, and hardware configured to perform identified computations. Processor 1255 may communicate with a chipset 1260 that may control input to and output from processor 1255.

In this example, chipset 1260 outputs information to output 1265, such as a display, and may read and write information to storage device 1270, which may include magnetic media, and solid-state media, for example. Chipset 1260 may also read data from and write data to storage device 1275 (e.g., RAM). A bridge 1280 for interfacing with a variety of user interface components 1285 may be provided for interfacing with chipset 1260. Such user interface components 1285 may include a keyboard, a microphone, touch detection and processing circuitry, a pointing device, such as a mouse, and so on. In general, inputs to system 1250 may come from any of a variety of sources, machine generated and/or human generated.

Chipset 1260 may also interface with one or more communication interfaces 1290 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1255 analyzing data stored in storage device 1270 or storage device 1275. Further, the machine may receive inputs from a user through user interface components 1285 and execute appropriate functions, such as browsing functions by interpreting these inputs using processor 1255.

It may be appreciated that example systems 1200 and 1250 may have more than one processor 1210 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method of training a hierarchical neural network in hardware comprising a plurality of neurons having tree structure connections between respective ones of the plurality of neurons to compute plausible inferences based on input data, the method comprising:
initiating a winner-take-all (WTA) neuron ensemble to connect to data input neurons and produce a winner-take-all;
attaching data records matching with top neurons and branching out at WTA junctions to form a hierarchy network tree;
converting a stream of the input data into neuron bipolar signals;
updating neuron weights with Hebbian and anti-Hebbian rules; and
repeating the attaching, converting, and updating until the input data is exhausted.

2. The method of claim 1, wherein the hierarchical neural network is a parallel distributed computation machine comprising a plurality of parallel processors.

3. The method of claim 2, further comprising:
partitioning the input data by attributes and samples into memory segments, distributed among each processor in the plurality of parallel processors;
training each hierarchy neural network in the plurality of parallel processors; and
merging the hierarchical neural networks into a hierarchy neural network system.

4. The method of claim 1, wherein the hierarchical neural network is trained for cluster data analysis,
wherein each path in the tree structure represents a cluster;
wherein each path of the hierarchical neural network together form mutually exclusive pattern profiles;
wherein each path containing only top-level nodes represents low-resolution/coarse pattern profiles; and
wherein each path containing all levels of nodes represents high-resolution/detail pattern profiles.

5. The method of claim 1, wherein the hierarchical neural network is trained for classification by:
inputting data records to activate matched neuron signals in the hierarchical neural network; and
causing the matched neuron signals to transmit signals along a path and reach a class neuron, wherein the class neuron determines a winner or produces uncertainty logic inference.

6. The method of claim 1, wherein the hierarchical neural network is trained for function approximation by:
inputting data records to activate matched neuron signals in a network; and
causing the matched neuron signals to transmit signals along a path and reach a pyramid neuron ensemble, wherein the pyramid neuron ensemble determines a winner, and wherein numerical output values are achieved through decoding of pyramid neurons in the pyramid neuron ensemble.

7. The method of claim 1, wherein the hierarchical neural network is trained for pattern profiling and pattern recognition by:
inputting data records to activate matched neuron signals in a network; and
causing the matched neuron signals to transmit the matched neuron signals along a path and retrieve a pattern for recognition.

8. The method of claim 1, wherein the hierarchical neural network is trained for knowledge extraction by:
inputting data values into a plurality of attribute neurons; and
activating paths that match with input data values.

9. A non-transitory computer readable medium having programming instructions stored thereon, which, when executed by a processor, causes a computing system to perform operations for training a hierarchical neural network in hardware comprising a plurality of neurons having tree structure connections between respective ones of the plurality of neurons to compute plausible inferences based on input data, the operations comprising:
initiating a winner-take-all (WTA) neuron ensemble to connect to data input neurons and produce a winner-take-all;
attaching data records match with top neurons and branching out at WTA junctions to form a hierarchy network tree;
converting a stream of the input data into neuron bipolar signals;
updating neuron weights with Hebbian and anti-Hebbian rules; and
repeating the attaching, converting, and updating until the input data is exhausted.

10. The non-transitory computer readable medium of claim 9, wherein the hierarchical neural network is a parallel distributed computation machine comprising a plurality of parallel processors.

11. The non-transitory computer readable medium of claim 10, further comprising:
partitioning the input data by attributes and samples into memory segments, distributed among each processor in the plurality of parallel processors;
training each hierarchy neural network in the plurality of parallel processors; and
merging the hierarchical neural networks into a hierarchy neural network system.

12. The non-transitory computer readable medium of claim 9, wherein the hierarchical neural network is trained for cluster data analysis,
wherein each path in the tree structure represents a cluster;
wherein each path of the hierarchical neural network together form mutually exclusive pattern profiles;
wherein each path containing only top-level nodes represents low-resolution/coarse pattern profiles; and
wherein each path containing all levels of nodes represents high-resolution/detail pattern profiles.

13. The non-transitory computer readable medium of claim 9, wherein the hierarchical neural network is trained for classification by:
inputting data records to activate matched neuron signals in the hierarchical neural network; and
causing the matched neuron signals to transmit signals along a path and reach a class neuron, wherein the class neuron determines a winner or produces uncertainty logic inference.

14. The non-transitory computer readable medium of claim 9, wherein the hierarchical neural network is trained for function approximation by:
inputting data records to activate matched neuron signals in a network; and
causing the matched neuron signals to transmit signals along a path and reach a pyramid neuron ensemble, wherein the pyramid neuron ensemble determines a winner or produces uncertainty logic inference, and wherein numerical output values are achieved through decoding of pyramid neurons in the pyramid neuron ensemble.

15. The non-transitory computer readable medium of claim 9, wherein the hierarchical neural network is trained for pattern profiling and pattern recognition by:
inputting data records to activate matched neuron signals in a network; and
causing the matched neuron signals to transmit the matched neuron signals along a path and retrieve a pattern for recognition.

16. The non-transitory computer readable medium of claim 9, wherein the hierarchical neural network is trained for knowledge extraction by:
inputting data values into a plurality of attribute neurons; and
activating paths that match with input data values.

17. A hierarchical neural network formed in hardware comprising:
a plurality of neurons having tree structure connections between respective ones of the plurality of neurons to compute plausible inferences based on input data, wherein the hardware is a parallel distributed computation machine comprising a plurality of parallel processors and the hierarchical neural network is distributed across the plurality of parallel processors.

18. The hierarchical neural network of claim 17, wherein each sub hierarchical neural network executing across the plurality of parallel processors are merged to form the hierarchical neural network.

19. The hierarchical neural network of claim 18, wherein each sub hierarchical neural network is trained independently.

20. The hierarchical neural network of claim 17, wherein the hierarchical neural network is trained for artificial general intelligence that mimics many human cognition capabilities, comprising one of knowledge acquisition, forecasting, decision-making, reasoning, or logic and inference.
